(19) United States
(12) Patent Application Publication
(10) Pub. No.: US 2009/0032525 A1
(43) Pub. Date: Feb. 5, 2009

(54) Soil-heating device particularly for soil covered by a synthetic surface

(75) Inventors: Fernand Scherrer, Mulhouse (FR); Jean-Claude Beisser, l' Argentiere La Bessee (FR)

Correspondence Address: YOUNG & THOMPSON, 209 Madison Street, Suite 500, ALEXANDRIA, VA, 22314, US

(73) Assignee: Fernand Scherrer, Mulhouse (FR)

(21) Appl. No.: 11/666,093

(22) PCT Filed: Oct. 28, 2005
(86) PCT No.: PCT/FR2005/002710

§ 371 Date: Sep. 23, 2008

(30) Foreign Application Priority Data
Oct. 28, 2004 (FR) 0411549

(51) Int. Cl. H05B 3/08; B32B 37/12; B32B 38/04

(52) U.S. Cl. 219/541; 156/250

(57) ABSTRACT

A soil-heating device, particularly for soil covered by a synthetic surface, of the type including a heated film (1). The device includes two sealed and electrically-insulating support sheets (1a, 1b; 1′a, 1′b), between which parallel conducting resistive strips (3,3′) are arranged over the length of the support sheet in pairs, such that, at one end (B) the strips are connected to two electrical supply connectors (L, N) and, at the other end (A), connected to each other by a conducting bridge (9).

The present invention relates to heating elements for grounds or land covered with a covering of synthetic or artificial complex type, in particular sports grounds such as tennis courts, football pitches, grass hockey pitches etc. with a view to making them frost-free or to melt the ice and/or snow covering them.

It is known that some grounds, in particular sports complexes or training areas, park gardens etc.. are covered with synthetic artificial elements, such as slabs or strips of polypropylene grass in some sports stadiums. To impart good stabilization to these grounds and elastic shock absorbance, which cannot be provided by the characteristics of the slabs themselves, these slabs are arranged on elastomeric sheets. However, due to their insulating nature, these sheets form a barrier to any heating system arranged underneath the elastomer layer, such as heating devices of fluid circulation type in particular.

As a result, the heating of this type of synthetic covering, up until now, has never been achieved efficiently despite a large number of attempts with this purpose in mind.

The constraints laid on heating devices of this type are multiple. Firstly these devices must be planar so that they can be positioned directly between the slabs and their elastomer support, and can therefore directly deliver heat to the slabs without any insulating element being inserted between the slabs and the heat source.

Also, they must be watertight to avoid any problem of ill-functioning as regards electric safety. Additionally, they must not form a barrier against drainage of rain waters or melted snow, and they must be available in strips of long length so that users can adjust the size of these devices to needs. Finally, it must be possible to arrange their surface sufficiently close to the ground surface, so that the artificial complexes concerned can be heated rapidly and homogeneously.

The purpose of the present invention is to propose heating means that are able to meet all the above-cited constraints and conditions.

The subject-matter of the present invention is therefore a ground heating device, in particular for grounds covered with coverings in synthetic material, of the type consisting of a heating film, characterized in that it comprises two support sheets that are electrically insulating and water-tight, between which parallel conductive strips are arranged which extend along the length of the support sheet and are associated in pairs so that at one end they are respectively joined to two electric supply terminals, and at the other end they are joined together by a conductive bridge.

To prevent the heating device from disturbing proper drainage of water such as melted snow or frost, orifices are arranged between the conductive strips across the device.

In one variant of embodiment, the conductive strips may be free with respect to the sheets.

Also, one of the sheets may be made in an opaque material and the other sheet may be made in a translucent material, the latter allowing visualization of the conductive strips.

To allow the connections to be made, a window may be cut out of one of the sheets so as to expose a surface area of strip making it possible to weld a conductive bridge which is to be fixed onto each of these strip surfaces so exposed. This conductive bridge and the joining of the strips to the electric supply conductors are in turn insulated by covering them with a piece of insulating, sealing sheet which is glued or welded.

Preferably, the conductive strips and the intervals separating them from each other are of the same width, and the conductive bridge between two strips is made of part of a strip.

Another subject-matter of the present invention is a method for fabricating a film intended to be used to produce a heating device of the above-cited type, characterized in that it comprises the steps consisting of:
gluing a conductive, resistive sheet in aluminium in particular, onto an insulating support sheet, in PVC in particular, by means of a transposable glue,
cutting parallel, longitudinal strips “mid-way” in the conductive sheet,
coating every other parallel, longitudinal strip with glue,
placing a watertight, insulating support sheet on the strips,
separating the respective components from each other consisting of a support sheet and respective conductive strips adhering thereto,
gluing a second support sheet onto each of said components, so that the conductive strips are respectively sandwiched between the two support sheets.

A further subject of the present invention is a method for fabricating the heating device, characterized in that it comprises the steps consisting of:
cutting the film crosswise to obtain the desired length,
electrically connecting the conductive strips in pairs at one end of the heating device,
forming electric supply terminals at the respective opposite ends of each of the pairs of strips.

Electric contacting with the conductive strips may be made by cutting out a window in one of the support sheets midway therein, removing the corresponding cut-out, welding the element to be electrically contacted and sealing the corresponding area by gluing a piece of insulating material.

One embodiment of the present invention is described below as a non-limiting example, with reference to the appended drawings in which:

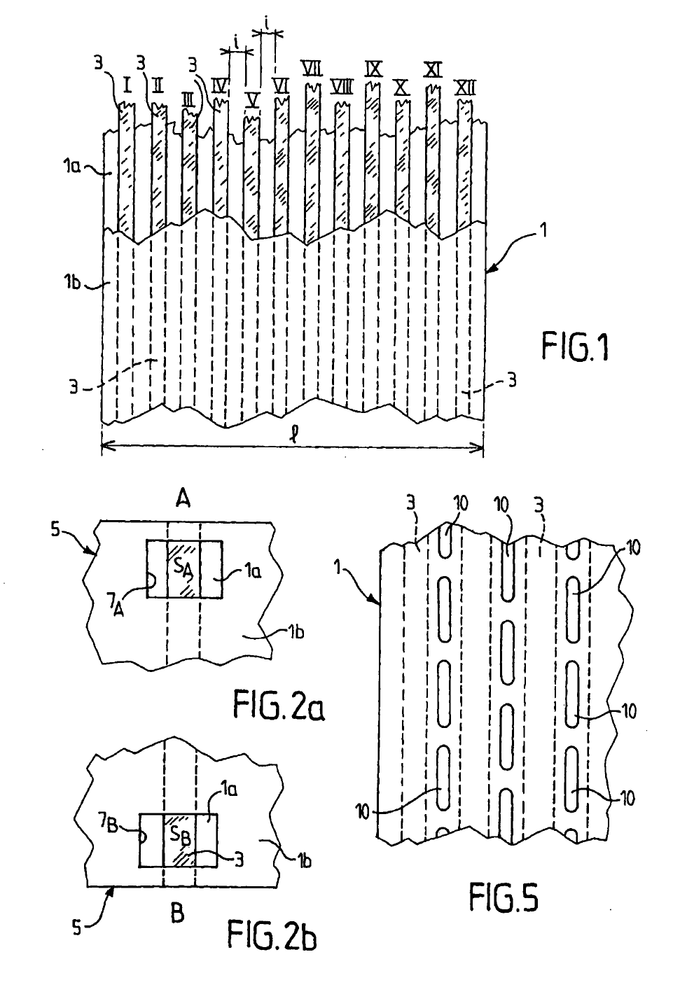

FIG. 1 is a plan view of a film forming a basic element allowing the implementation of the present invention.

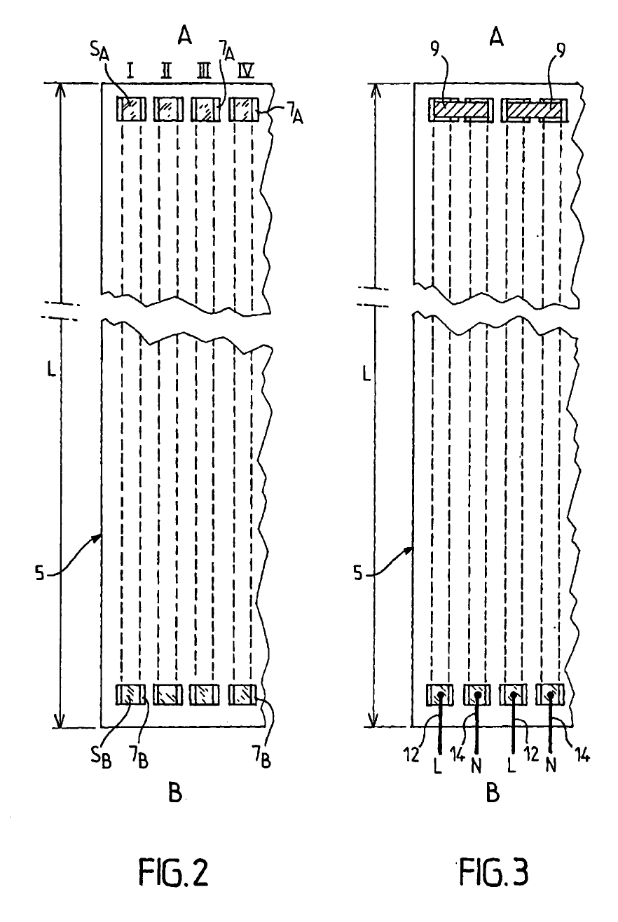

FIG. 2 is a partial plan view of a heating element obtained from the basic element shown FIG. 1, after opening windows to expose the conductive strips at its two respective ends.

FIGS. 2a and 2b are enlarged, partial plan views of the upper part and lower part of a heating element in its electrical connection areas.

FIG. 3 is a partial plan view of the heating element shown FIGS. 2 to 2b after making the electric connections.

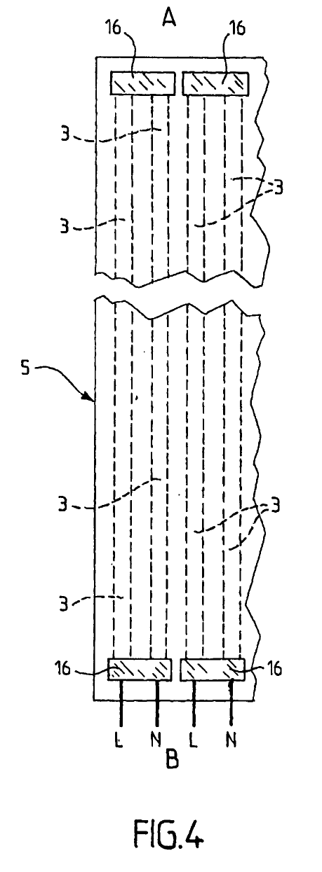

FIG. 4 is a partial plan view of a completed heating element ready to be placed in position under the artificial complex to be heated.

FIG. 5 is a partial plan view of a variant of embodiment of a film intended to be used to fabricate a heating device according to the present invention.

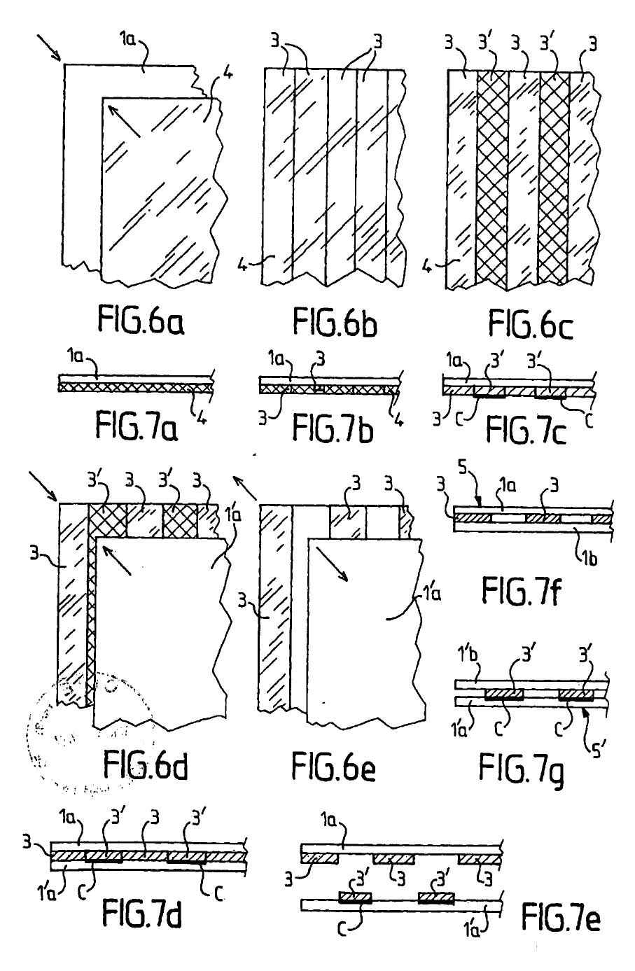

FIGS. 6a to 6e are partial plan views of different successive phases of a variant of preferred embodiment of the method for producing a film according to the invention.

FIGS. 7a to 7g are cross-sectional circuit diagrams of the elements shown in the previous figures during the different assembly phases.

FIG. 1 shows a basic element 1 intended to allow the user to form a heating device of the invention, in relation to the dimensional characteristics imposed by the geometry and size of the ground to be heated.

The basic element 1 is therefore formed of two assembled sheets of a support in polyvinylchloride (PVC), respectively 1a and 1b, between which a series of conductive, resistive strips 3 has been sandwiched, in aluminium of narrow thickness, which are arranged so that they lie parallel and extend along the length of the support sheets. To facilitate the maintaining in position of strips 3, the sheets 1a and 1b can comprise an adhesive surface.

More precisely, in the present example of embodiment of the invention, the two support sheets 1a and 1b and the metal strips 3 forming the basic element 1 have a width l of approximately 120 cm and a length in the order of several dozen metres. Over width l of the two support sheets 1a and 1b, twelve conductive strips 6 cm wide are arranged, numbered I to XII and spaced apart by one same interval i of 4 cm.

From this basic element 1, and according to the size and geometry of the ground it is desired to heat, the user cuts lengths L in this basic element (FIG. 2) which will provide the same number of heating elements 5.

To form each of these heating elements 5, as shown FIGS. 2, 2a and 2b, the user cuts out respective windows 7_{A} and 7_{B} at the two ends A and B thereof, these windows being cut through the thickness of one sheet, namely sheet 1b in the present example, so as to expose over a small surface area S_{A} and S_{B} the two respective ends of each of the conductive strips.

The twelve strips 3 are then electrically connected two by two, as shown FIG. 3, by placing at their end A an electrically connecting conductive bridge 9 so that each of these pairs of strips forms a closed electric circuit. The two other ends (side B) of these two conductive strips 3 are respectively connected to an electric conductor 12 communicating with a phase and to an electric conductor 14 communicating with neutral. Once these different electric connections have been made, from each of said closed electric circuits a heating element 5 has been formed. This heating element 5 is supplied under very low voltage i.e. a voltage possibly varying substantially between 5 volts and 48 volts which, in relation to the chosen voltage supply, will allow control over the calorific power delivered by this heating element.

During a last step, as shown FIG. 4, the water-tightness of the connections is ensured at the bridges 9 and connections of the electric conductors, by covering them with sealing elements 16 which are fixed either by gluing or by heat sealing. These covering elements 16 may for example be of the same type as the material forming the insulating sheets 1a and 1b, but must then additionally be made in a water-tight material.

It is also possible according to the invention to cut out the upper windows 7_{A} (side A) and lower windows 7_{B} (side B) in a single operation.

It will be understood that the present invention is of particular interest insofar as, starting with a basic element of long length wound in a roll and using much reduced tooling, it allows the fast, easy forming of heating elements of any length in relation to the size and shape of the ground to be heated.

In one variant of the present invention shown FIG. 5, provision is made for elongate openings 10 across the basic element 1 so that if the heating elements 5 are covered with earth or the artificial complex to be heated, rain waters, run-off waters etc . . . are able to drain off through these openings, thereby avoiding stagnant water from disturbing the proper functioning of the heating elements and ensuring proper evacuation of rain waters or thaw waters.

With reference to FIGS. 6a to 6e and 7a to 7g one embodiment of the invention is described below which is of particular interest regarding ease of implementation and production costs.

During a first step (FIGS. 6a and 7a) of this preferred embodiment of the invention, an aluminium sheet 4 is glued onto a support sheet 1a in PVC using a so-called “transposable” glue i.e. a glue of low adhesive power allowing easy detaching of the object it is intended to fix and its subsequent re-gluing onto another support.

Then during a second step (FIGS. 6b and 7b) the aluminium sheet 4 is cut in longitudinal direction to form a series of adjacent strips 3. Said cutting is of so-called “midway” type i.e. it stops at the surface of the support sheet 1a in PVC.

During a third step (FIGS. 6c and 7c) a glue C is coated onto every other strip 3, namely strips 3′.

During a fourth step (FIGS. 6d and 7d) a second support film in PVC 1′a is placed over the surface of strips 3, this film only adhering therefore to the longitudinal strips 3 coated with glue C.

During a fifth step (FIGS. 6e and 7e) the previously formed assembly is “de-matrixed” i.e. the two support sheets 1a and 1′a are separated. During this separation, it will be understood that strips 3′, on account of the presence of glue C, will remain fixed to support sheet 1′a (the adhesive power of the glue being greater than the power of the “transposable” glue) whilst strips 3 not coated with glue C will remain fixed by the transposable glue onto sheet 1a. Therefore, as shown FIG. 7f, the remaining operation consists of covering these two elements with respective PVC support sheets 1b and 1b′ to obtain two heating elements 5 and 5′.

Said embodiment is of interest in that it allows use of the entire surface of the aluminium sheet 4, providing particularly good cost-price performance of the heating film, firstly owing to the method's simplicity in its implementation and secondly due to the fact that it allows two of these heating films to be fabricated during one same production cycle.

1-12. (canceled)

13. Ground heating device, in particular for grounds covered with coverings in synthetic material, of the type consisting of a heating film (1), characterized in that it comprises two electrically insulating and watertight support sheets (1a, 1b; 1′a, 1′b), between which parallel, conductive and resistive strips (3, 3′) are arranged which extend along the length of the support sheet, and which are associated in pairs so that at one end (B) they are respectively joined to two electric supply terminals (L, N) and at the other end (A) they are joined together by a conductive bridge (9).

14. Device according to claim 13, characterized in that, between the conductive strips (3, 3′), the film (1) has orifices (10) passing through it.

15. Device according to claim 13, characterized in that the conductive strips (3, 3′) are free with respect to the sheets (1a, 1b; 1′a, 1′b).

16. Device according to claim 13, characterized in that one of the sheets (1a, 1b; 1′a, 1′b) is made in an opaque material and the other sheet is made in a translucent material.

17. Device according to claim 13, characterized in that the conductive bridge (9) between two strips (3, 3′) is made of a strip element.

18. Device according to claim 17, characterized in that a window (7_{A}, 7_{B}) is cut out of one of the sheets (1a, 1b) so as to expose a small strip surface (S_{A}, S_{B}), and the conductive bridge (9) is fixed onto each of these said strip surfaces.

19. Device according to claim 18, characterized in that the conductive bridge (9) and the joining of the strips (3, 3′) to the electric connection are insulated by covering these elements and fixing thereto a piece of insulating, watertight sheet, in particular by welding or gluing.

20. Device according to claim 13, characterized in that the conductive strips (3, 3′) and the intervals separating them from each other are of the same width.

21. Film intended to be used to form heating devices according to claim 13, characterized in that it consists of two electrically insulating and watertight support sheets (1a, 1b), between which parallel, conductive strips (3, 3′) are arranged which extend along the length of the support sheets.

22. Method for fabricating a film according to claim 21, characterized in that it comprises the steps consisting of:
gluing a conductive, resistive sheet (4), in aluminium in particular, onto an insulating support sheet (1a), in PVC in particular, using a transposable glue,
cutting parallel, longitudinal strips (3) “midway” in the conductive sheet,
coating every other parallel longitudinal strip (3′) with glue (C),
placing an insulating, watertight support sheet (1′a) on these strips,
separating the respective components from each other consisting of a support sheet (1a, 1′a) and respective conductive strips (3, 3′) adhering thereto.
gluing onto each of said components a second support sheet (1b, 1′b) so that the conductive strips (3, 3′) are respectively sandwiched between the two support sheets (1a-1b; 1′a-1′b).

23. Method for fabricating a heating device from a film according to claim 21, characterized in that it comprises the steps consisting of:
cutting the film crosswise to obtain desired length (L),
electrically connecting the conductive strips (3, 3′) in pairs at one end (A) of the heating device,
forming the electric supply terminals (12, 14) at the respective opposite ends of each of the pairs of strips (3, 3′).

24. Method according to claim 23, characterized in that the electric contacting with the conductive strips (3, 3′) is made by cutting out a window (S_{A}, S_{B}) midway in one of the support sheets (1b, 1′b), removing the corresponding cut-out, welding the element (9, 12, 14) to be placed in electric contact and sealing the corresponding area by gluing a piece of insulating material.
